(19) United States
(12) Patent Application Publication
(10) Pub. No.: US 2003/0117545 A1
(43) Pub. Date: Jun. 26, 2003

(54) Pixel arrangement for flat-panel displays

(76) Inventors: Timothy Martin Coker, Maidstone (GB); William Alden Crossland, Essex (GB); Nicholas Lawrence, Cambridge (GB); Nalliah Raman, Cambridge (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/168,803

(22) PCT Filed: Dec. 22, 2000
(86) PCT No.: PCT/GB00/04989

(30) Foreign Application Priority Data
Dec. 23, 1999 (GB) 9930529.4

(51) Int. Cl. G02F 1/1335

(52) U.S. Cl. 349/61

(57) ABSTRACT

A flat-panel modulator includes a plurality of separately modulatable elements or pixels in which the modulating elements on the panel are arranged, notionally or physically, into patches or blocks (shown schematically as 53a, b, c) of individual modulating elements such that space between each patch exists which has no modulating elements. Addressing lines can be located in the space between the blocks, decreasing resistivity. Also the optical resolution of the magnifying optics is much better than if the entire panel were imaged as a whole. Furthermore a seamless image can be built up using suitable optics (51) between the modulator blocks and a screen (52), at least some of the blocks being magnified.

This invention relates to flat-panel displays, particularly liquid-crystal displays, more particularly photo-luminescent liquid-crystal displays (PL-LCDs). This latter type of display is described in WO 95/27920 and involves the use of narrow-band UV activation light illuminating photo-luminescent output elements.

One of the principal limitations to flat-panel technology is due to the techniques by which the individual pixels are addressed. Prior-art methods utilise passively addressed pixels which have multiplexability limitations, or actively addressed pixels, which in principle allow each pixel to be individually addressed. Examples of active addressing include TFT arrays, Plasma-Addressed Liquid-Crystal Displays (PALC) and Plasma Display Panels (PDPs). The cheapest by far of all of these techniques is passive addressing, but this is severely limited in terms of how many pixels (or rows of pixels) can actually be addressed.

The invention contemplates laying out the pixels in a different manner to prior-art displays; it is then possible to passively address more pixels on a panel than has been previously been the case. The method used in this application is to sub-divide the pixels on a panel into smaller blocks (i.e. smaller than the whole panel) or ‘patches’; this leaves space on a panel that is not covered with pixels and this space can be used to address the patches individually. In this way the multiplexing limits of STN panels in particular only apply within each block and not over the entire panel. To give an example, if the multiplex limit is 50 rows, then without blocked-up pixels an LCD panel would be limited to 50 rows (which is obviously insufficient for a general-purpose display), but, if the pixels are arranged in blocks, then perhaps three blocks of 50 rows each can be addressed and the number of addressable pixels on the panel is increased thereby.

Although this method of blocking up the pixels within a modulator is advantageous for addressing purposes, there is clearly a disadvantage, namely, that the ‘patchy’ nature of the pixels will be evident if the modulator is viewed directly. However, optical methods similar to those disclosed in the applicants' previous WO 00/17700 can be used in a novel way to overcome this problem and create a display. Additionally this principle can be further extended to create a ‘tiled’ display from a plurality of smaller sub-displays. Although the concept of such a tiled display is known (see for example KC Tung—GB 2236447, U.S. Pat. No. 5,751,387 from Fujitsu Ltd or U.S. Pat. No. 5,661,531 from Rainbow Displays Inc), this approach utilising a modulator with pixel blocks is new.

According to the invention in its most general aspect, therefore, there is provided a flat-panel modulator, such as a liquid-crystal display, including a plurality of separately modulatable elements or pixels, in which the modulating elements of the panel are grouped together in blocks or patches such that space between each patch exists which has no modulating elements, or at least no functioning elements. The space between patches is of course substantially greater than any spacing there might be between adjacent pixels within a patch.

An aspect of these pixel blocks that is highly advantageous arises from the fact that the space between the patches need not be transparent. This space can be used to supply extra addressing lines to individual blocks as described above; the fact that the extra lines need not be transparent means they can be made from a metallic material which will dramatically lower track resistance. This aspect is particularly advantageous for video-rate modulators where a high frequency response is required.

Prior-art modulator panels are limited in the speed with which they can be addressed because of RC effects of the addressing lines; in other words the maximum frame rate with which such a modulator can be driven is limited. This effect is so large that, in general, the viscosity of the liquid crystal has to be artificially increased so that the response time of the material is sufficiently slow to avoid frame response and/or flicker. This effect is one of the principal reasons why passively addressed modulator panels, in particular, are not fast enough to display video. Thus any decrease in the RC of the addressing lines will increase the frequency with which the modulator can be driven, thus reducing the required viscosity of the liquid crystal and therefore allowing video-rate data to be displayed.

Arranging the pixels in separate blocks can be done in various ways. One has already been mentioned, that is, within a column of blocks individual blocks can be addressed independently. In the absence of such independence each row of pixels would be addressed consecutively in a normal row scan. However with independent blocks of pixels there exists an extra degree of freedom; one can:

a) Address each row consecutively as normal; this approach has the advantage only that addressing lines to the blocks can be of a low-resistivity but non-transparent material;

b) Address one row within each block simultaneously, thus increasing the overall frame scan rate and improving STN multiplexing limits(where passive addressing is employed).

This is also a form of multi-line addressing; or

c) Address more than one row in each block at a time; this is utilising the independent blocks to extend multi-line addressing methods further.

In addition to block independence within a column, one can also introduce block independence within a row. Row independence allows one to:

d) Make increased use of metallic conductors, thus increasing addressing rates as a consequence of the reduced RC time constants; or

e) Address all columns in consecutive or random block order. This may facilitate avoidance of other artifacts, particularly motion artifacts, or it may have a synergistic effect when combined with decoding of video data such as that contained in MPEG data streams (see below).

In the extreme, of course, blocks are independent by both rows and columns and therefore the entire array can be addressed in the time it takes to address a single block. The penalty here is that the number of row and column drivers is increased, thus increasing costs. Alternatively blocks can be addressed on a random or arbitrary basis, which may have utility in combination with data decoding schemes or in further avoidance of motion artifacts.

In general, increasing the overall frame rate, be it by use of row and/or column independence or as a result of the reduced RC time constants of metallic conductors, will reduce frame rate artifacts. Additionally, some motion artifacts can also be reduced by decreasing the liquid-crystal viscosity (where a liquid crystal is used). Normally this cannot be done as it would introduce frame rate artifacts (such as flicker and frame response), but these have been eliminated or reduced by the increase in frame rate.

Advantages so far described have related to the mechanics and electronics of actually addressing a particular pixel or block of pixels, but there are further advantages for this approach. For instance many coding and decoding schemes for video data rely on a subdivision of the pixels within an image into blocks. The extra freedom of actually addressing each block independently of others will further facilitate all such schemes. As an example, MPEG coding relies partly on subdividing an image into blocks of pixels and then correlating smaller blocks within those blocks from one frame to the next. Once this is done the subsequent block can be coded simply as a number of ‘displacement’ vectors from the previous frame. Thus, on decoding, the new frame is generated block by block from the preceding frame according to the displacement vectors. Given that a block can be displayed individually on a modulator (in that it can be addressed individually) according to embodiments of the invention, there is an obvious synergy between the decoding and the displaying of this data.

The layout of the pixel blocks on the modulator can be done in a variety of ways. For instance each block on a modulator can be of a uniform size and position across the modulator. This would represent one extreme, the other extreme being total non-uniformity. The actual choice of block layout will be determined by other system aspects.

It is possible to form the separate pixel blocks on the modulator in at least two ways. The first, and preferred, approach is as has been previously described; that is, the pattern of pixels on the panel would be exactly that required in terms of position, size and spacing. Alternatively a panel with a uniform pixel array could be utilised and the pixels addressed in such a way that the pattern they display is that required. Note that the pixel arrangement actually has two aspects: spacing (i.e. the creation of pixel blocks) and actual pixel size. The requirement for variation in pixel size will be explained below, but creation of larger pixels will involve a number of pixels being grouped together to form these larger pixels. Creation of space between patches will involve some pixels being permanently off. In practice, of course, these permanently off pixels would be masked off so that no light would pass through them, regardless of how they were addressed. The disadvantage of this scheme is that no space is freed to allow the patches to be addressed individually, but the advantage is that such a panel is straightforward to manufacture with existing facilities.

Whilst pixel blocks within a modulator have at least the advantages described so far there is the problem that, where an image is displayed on the modulator, this will show the gaps between the blocks (when viewed directly) and this is obviously unsatisfactory. However it is possible to include an optical arrangement between the modulator and the viewer that can be adapted to overcome this problem. In principle this sort of approach can be used for conventional displays but is particularly advantageous for PL-LCD architectures, as explained below.

The applicants' previous WO 00/17700 discloses a method where an optical arrangement is interposed between a modulator and a photo-luminous output screen, this arrangement acting to project the plane of the modulators onto the plane of the output screen in a manner analogous to, but much more compact than, conventional projection displays. A similar principle is applied here to overcome the aforementioned problem that the gaps between pixel blocks are visible.

In order to understand how this is achieved it is important to realise that, when the pixels are grouped together in blocks, the individual pixel size has to be reduced in order to create the ‘spare’ room around each block. Therefore, in order to recreate the full image, each block of pixels has to be magnified and this is achieved by the use of a suitable optical arrangement. The optics are designed so that the images of the blocks on the output screen are of the correct size, shape, position and orientation and align to produce a proper image, particularly one in that the gaps between pixel blocks have been eliminated. Since each pixel has been magnified the resultant image is necessarily magnified as well.

This concept of projecting and magnifying the blocks of pixels on a block-by-block basis to overcome the problem of the gaps is referred to here as composite imaging. Whilst the principles work in theory for conventional displays, practical problems arise which mean that application to PL-LCD architectures is particularly advantageous. It is also important to note that the optical projection described in this application is different to prior-art projection, particularly that described in WO 00/17700.

According to one application of the invention, therefore, there is provided a display comprising a flat-panel modulator as previously described, a means, such as a backlight, for producing narrow-band activation light, an output screen carrying photo-luminous output elements which emit visible light in response to the activation light, and an optical arrangement adapted to project the image of the modulating means onto the output screen, the optical arrangement being further adapted to magnify each block of pixels on the modulator on a block-by-block basis to create a composite image on the output screen.

The concept of composite imaging has a number of novel and inventive aspects that bear further discussion, but it should be noted that although the modulator with pixel blocks on the one hand and the composite imaging concept on the other are very much complementary ideas, the pixel blocks concept has particular advantages that do not relate to composite imaging. For instance the addressing advantages of pixel blocks described above are independent of the optics, in that they need not be applied to the modulator—i.e. conventional means of addressing the pixels can be used without modification. Note, however, that this is not so for the patches themselves

if they are present on the modulator and are not to be present on the final display then the optics need to be introduced. The nature of composite imaging is that it is not independent of pixel patches on the modulator

if composite imaging is being used then pixel patches will be present and vice versa.

The complementary nature of the pixel blocks and the optical arrangement means that if one determines the layout and size of the pixel blocks first, this will dictate the function of the optical arrangement. On the other hand if one determines first the magnification and size of each independent set of optics within the optical arrangement this will determine the size and position of the pixel blocks. Using the former approach, one extreme is to make the size and spacing of the blocks uniform (and therefore the magnification of the optical arrangement must be uniform also). Another extreme is to use unity magnification only (sometimes referred to as relay imaging or image transfer) together with uniform block spacing. In this case, however, each pixel block would only be conceptually and not physically distinguishable from neighbouring blocks if a proper composite image is to be formed (i.e. one without gaps between blocks).

The central aspect of composite imaging is the nature of the optical arrangement which is adapted to achieve the composite image. Simple projection as described in WO 00/17700 will not suffice, because the presence of the blocks will still be apparent in the projected image. The solution as presented here is that each block has an individual optically independent arrangement that projects an image of the block with the correct magnification so that the composite image of all the blocks that is created on the output screen is correct (i.e. an accurate representation of the intended image). By ‘optically independent’ is meant that the ray paths through such a set of optics are physically separate from similar ray paths through a set of neighbouring optics; this phrasing is used because the actual optics themselves may or may not be physically distinct from block to block.

The presence of these independent optics for each block leads to further advantages for the invention over prior-art displays, as follows. Each set of optics will accept from each field point on the object (being the block of pixels), only those rays emerging within a certain range of angles. The nature of this ‘acceptance’ is that rays outside these angles will at some point miss a lens surface. Where a vignetting means is employed these rays will be absorbed or blocked and will therefore not contribute to an image (i.e. are rejected). An alternative to vignetting is to collimate the backlight to ensure that all emerging rays are within the acceptance angles of the optics; a backlight that is collimated in this way will be more efficient than an un-collimated backlight because the un-collimated light would otherwise be vignetted or lost.

In general those rays accepted by the optics will also be those which are switched with high contrast by the optical effect of the modulator (in the case where the modulator is a liquid crystal, which is the preferred embodiment). This in turn will lead to better integrated contrast for a PL-LCD display. Thus the two aspects of contrast and collimation are linked together by overall system parameters of integrated contrast and light efficiency. In the case of passive-matrix modulators, the collimation effect can also enhance the degree of multiplexability of the electro-optic effect, providing further advantages for the invention over prior art.

A further aspect of the invention that is highly advantageous, but is a consequence more of composite imaging than of pixel patches, is the notion of tiling of smaller displays to create a single larger display. Much research effort in recent years has been directed towards the manufacture of very large flat-panel displays; for example, TFT displays are now being produced with screen diagonals of 17″ and bigger. Other technologies are capable of much larger sizes, for example Plasma Display Panels (PDPs) or Plasma Addressed Liquid-Crystal Displays (PALC) which have been demonstrated with screen sizes of 40″ and over. These are currently the two main contenders for direct view screens of this size, but both have disadvantages in terms of cost and performance. Additionally, and in principle, conventional LCDs could simply be made larger, but it is believed that this will always be too expensive in that the yield of such large displays will be too low for such an approach to be commercially viable and in any case current manufacturers are not anticipating even 30″ panels until 2010.

Another approach towards achieving the goal of a very large flat-panel display has been to group together in a matrix or regular array a number of smaller displays, thus forming one large display, the aforementioned ‘tiling’. The principal problem with this approach is that the smaller displays cannot be perfectly butted up to each other, so there is always a certain area in between individual displays that shows no part of the picture. This area is often referred to as dead space whilst a display without such dead space is often called a ‘seamless’ display.

Many prior-art inventions have been concerned with either avoiding or minimising this dead space. For example Kreon Screen International's EP 0114713 describes a light guide component that is placed in the dead space between a number of CRT displays and reduces or eliminates the dead space effect, whilst U.S. Pat. No. 5,828,410 (RC Drapeau) discloses a similar idea. GB 2315150 from LG Electronics describes a method for manufacturing and assembling a number of liquid-crystal sub-displays in such a way that dead space is eliminated. A similar patent from Rainbow Displays Inc. (U.S. Pat. No. 5,661,531) describes how the seamless effect can be achieved by increasing the inter-pixel spacing within a modulator to make it comparable to the gap between two tiled modulators. This method has particular disadvantages in that additional means for light masking and de-pixellating are required in order to create a satisfactory display. GB 2274225 from Sony, meanwhile, discloses a different method for ameliorating the dead-space problem whereby an illumination means designed to illuminate the dead space is employed in such a way that the grid-like dead-space effect is mitigated. All these methods could be described as mechanical or partly mechanical methods for overcoming the dead-space problem.

An alternative to a mechanical or partly mechanical solution is to use a purely optical one. The main principle, as disclosed in GB 2236447 (KC Tung), is that a plurality of LCDs are arranged together in an array, as closely together as possible. Viewed directly dead space would be observed; however, a lens is used to produce a magnified image of each sub-display. In this way, whilst the actual displays cannot be perfectly butted up to each other, their images can; thus a large image is formed without dead space. U.S. Pat. No. 5,751,387 from Fujitsu Ltd. describes a particular fresnel lens and optical arrangement embodying this principle, whilst GB 2317068 and GB 2329786A from CRL Ltd. also uses the same principle except that micro-lenses or Gabor super-lenses are used to achieve the magnification, rather than a single lens. It should be noted that, in the case of the Fujitsu and CRL methods where a real image is produced, what is actually being done is no more than projection of an image onto a screen. Also the Gabor super-lenses are not best suited for magnifying with high resolution.

These optical methods can be improved if they are combined with a PL-LCD architecture as described in WO 00/17700 but there still remain imperfections in the image so produced. The optical methods employed by Fujitsu and CRL are variations on the theme of projection and, while in general terms projection is entirely feasible without unacceptable degradation of image quality, where this is achieved the throw is generally very great in comparison to the size of the image (the original image, not that formed on the screen). To give an example, 35 mm slides can be very easily projected to give images of considerable size, provided that the throw between slide and screen is several metres.

Where the requirement is to manufacture a flat-panel display the ‘throw’ between the modulator panels that are being tiled and the secondary or output screen is generally very small in comparison to the dimensions of the full display. Where special methods are used to achieve the required magnification with the required throw (for example the Fujitsu or the CRL patent applications), it is done at the expense of image quality. This is true even though the amount of magnification required is actually quite low. For example, the dead space between two 30 cm sub-displays may only be 1 or 2 cm. The amount of magnification required to overcome this is therefore only about 7%. Nevertheless, with the short throw that is possible in a flat-panel architecture, high image quality over all of the magnified image is not possible. An empirical proof of this could be considered to be the fact that no displays using the optical principle have yet been marketed despite the fact that the patents are 3-4 years old and the market for such displays is thought to be lucrative.

The solution to this problem is in fact an extension of composite imaging. In the case of a display in accordance with the invention, as it has so far-been described, it is implicit that magnification takes place between the modulator panel and the output screen; thus there is further synergy between the two concepts of tiling and composite imaging. There is a fundamental difference, however, between magnification as described in the prior art quoted here and the magnification that takes place according to embodiments of the invention. Prior-art systems have all magnified the entirety of the image displayed on the modulator, i.e. the liquid crystal cell or panel, in one operation, as it were, while the systems described here achieve magnification by sub-dividing the image on a single modulator substrate, magnifying each block independently and ‘re-assembling’ the magnified block images into the final composite image. The sub-division and re-assembly allows magnification over an area without associated image degradation. Once this is achieved all that remains is to design the optics for the required amount of magnification necessary for the purpose of tiling panels together.

According to a further development of the invention, therefore, there is provided a display comprising a plurality of modulators, as previously described, arranged in a preferably regular array or matrix; a means, such as a backlight, for producing narrow-band activation light; a single large output screen preferably carrying photo-luminous output elements which emit visible light in response to the activation light, and an optical arrangement for projecting the plane of the modulators onto the output screen in such a way that the projected composite image of each modulator, formed by individually magnifying each block of pixels on each modulator, is larger than the modulator by a sufficient amount to allow a seamless composite image of all the modulators to be formed on the output screen. By ‘a single large output screen’ is meant that the screen is larger than any individual modulator panel, the actual size being naturally dictated by the number of panels that are tiled together and the degree to which each is magnified.

As previously mentioned the layout scheme for the pixel blocks on the modulator(s) or the magnification within the optical arrangement can be uniform or non-uniform. One application of a non-uniform scheme is the case where central blocks are projected with unity magnification but the blocks around the periphery are magnified. In this case, conceptually, the central block can be considered either as a single large block, or as a number of contiguous smaller blocks. Either way the central region is separate and distinguished from the peripheral blocks. The advantage of this scheme is that the central portion of the modulator is effectively unchanged from the prior art, but the presence of the peripheral blocks, and the magnification of those, will allow multiple modulators to be seamlessly tiled. Schemes such as this, whereby only the periphery is magnified, are referred to as peripheral magnification schemes, but this is not to say that these are the only schemes that can achieve a tiled display.

In all tiling applications of the invention the required degree of magnification is that set by the requirement to assemble sub-displays together; typically up to 20 mm of extra space is required for this. This can be achieved by, for example, 3:1 magnification of a 10 mm pixel block. However, this degree of magnification is only actually required at the periphery; elsewhere one can use an equal degree of magnification, i. e. equal to the magnification of the periphery (which would be the uniform case), lesser magnification or even greater magnification. In the case where lesser magnification is used, the extreme is that of unity, which is the scheme described at the start of the preceding paragraph. On the other hand any value of magnification between these two can be utilised.

An alternative embodiment of the peripheral magnification principle when used for tiling is to use separate peripheral modulators, in effect to dismount the peripheral areas. This embodiment has the advantage that the modulators that represent the central regions will be very little different from current modulators; the disadvantage is the additional cast of the peripheral modulators themselves, and their mounting. The scheme can also be implemented in two ways: one is such that the modulators and the peripheral modulators are mounted in substantially the same plane such that the working distance for every set of optics is the same; on the other hand the peripheral modulators can be mounted closer to or even further from the output screen than the other modulators.

The immediate consequence of the different magnifications that are implied by any non-uniform composite scheme is that, as the pixel size on the output screen must normally be uniform over its entire area, the pixel size on the modulator cannot be. To take as an example the peripheral scheme previously described, the modulator has two principal areas: a peripheral area containing a number of blocks of pixels and a central area which is simply relay-imaged onto the output screen. If the peripheral blocks are magnified by a factor of three in order to accomplish tiling, then the pixels within these blocks must be three times smaller than within the central block.

A second consequence of any non-uniform scheme is that the intensity with which the patches are lit must be proportional to the area magnification (or to the square of the linear magnification); this variation in illumination is a disadvantage of all non-uniform schemes compared to the uniform scheme. For example if the central region is imaged with unity magnification and the peripheral blocks with 3:1 magnification then these patches will need to be lit with nine times the light intensity of the central region. This can be achieved, for example, by arranging separate, more intense, lighting for the peripheral regions. Where separate peripheral modulators are employed separate lighting arrangements for these modulators is particularly advantageous.

An alternative method would be to integrate with the backlight an arrangement whereby the light which reaches the peripheral patches is more intense than that which reaches the central regions. The most simple way of doing this is to place a 11.1% transmissive neutral density filter between the backlight and the central regions, so that the light reaching the periphery will be nine times as intense as that reaching the central region (to use a particular numerical example). The disadvantage of this method is that it is very inefficient. A better method would be to use a partial mirror rather than an absorbing filter, so that the rejected light can be regenerated in the backlight cavity rather than simply absorbed by the filter. Of course one advantage of the uniform block layout scheme is that the matter of non-uniform illumination is not relevant.

Optically two different requirements for composite imaging have now been stated: unity magnification (relay imaging or image transfer) and ‘normal’ magnification. Magnification can be achieved by conventional optics, albeit on a smaller scale than hitherto used, or by use of micro-lens arrays or GRIN arrays, in the manner described in the applicants' own WO 00/17700. Where unity magnification is employed, it may be necessary to do so over the entire central area of a modulator—some tens of centimetres in extent. One possible approach is to again use micro-lens or GRIN lens arrays as in WO 00/17700. Another approach is to use similar conventional optics to those used for achieving magnification, except that only unity magnification is performed.

Where conventional optics are used these are referred to as ‘mini-lenses’ as, in size, they are midway between the normal size of lenses, and micro-lenses—typically these mini-lenses are 20 mm in diameter and can correspond to one block or patch. One major difference between mini-lenses and micro-lenses is that the image produced by the mini-lenses is inverted whereas the image produced by the micro-lens arrays is erect. Where mini-lenses are used the data that each block is displaying will need to be inverted in order to cancel out the subsequent inversion of the optics.

Another aspect of embodiments of the invention that is advantageous is that, in principle, the magnification and image transfer of the modulator can take place accurately without regard to the degree of collimation of the backlight. This is so provided that the optics are properly vignetted; that is, light which would otherwise reach the wrong set of optics, and would therefore be imaged into the wrong place, is blocked from so doing. Thus a completely un-collimated backlight can be made to function correctly. Although the blocking of this stray light implies a loss which is undesirable, on the other hand collimation is inherently less than 100% efficient. The preferred embodiment would obviously be the most efficient one, but it is not necessarily true that an un-collimated but vignetted scheme is better than a collimated scheme or vice versa. Collimated backlights are described in WO 95/27920 or WO 98/49585.

A further aspect of the invention relating to the presence of the optical arrangement that is advantageous is that pin-cushion or barrel distortion can be corrected for by adapting the shape and layout of the pixel blocks. Distortion of this sort is peculiar in that only the shape of an image is affected; such a distorted image is otherwise perfect (for example it can still be perfectly focussed, etc.). Correction for this distortion can be achieved in this way because the distortion can be predicted in advance. In other words, if one-know that a perfect square is distorted into a pin-cushion shape, one can work out the correct barrel shape that will be distorted back into a perfect square (pin-cushion and barrel distortion are the inverse of each other). To use a mathematical analogy, the optics can be represented by a two-dimensional transfer function, from which the inverse transform can be deduced. If this inverse transform is applied to the required image shape (in this case an array of recti-linear pixels) and this shape is then imaged by the optics, the further transform is cancelled out by the prior inverse transform resulting in the required shape being correctly imaged. Given that distortion of this nature has to be eliminated, since otherwise it will not be possible to assemble a composite image correctly, the alternative solution that would have to be utilised is to optimise the distortion out of the optics. Whilst this is possible it results in optics that either are more complex and expensive than they would otherwise be or have reduced performance in other respects, for example resolution. Thus this method of correcting for distortion allows an additional degree of freedom in the design of the optics that can be used to improve on the performance that could otherwise be achieved.

It will be noted that peripheral magnification and composite imaging, as principles, are not restricted to PL-LCD architectures (i.e. where UV activating light is modulated onto a phosphor-type output screen) but are most suitable for these types of display for several reasons. The first is that the secondary screen, being in the case of PL-LCD the photo-luminous output screen, is beneficial rather than disadvantageous. Additionally, the use of optics in this way, whilst applicable to both PL-LCD and conventional architectures, is advantageous to PL-LCDs in relation to conventional systems. This is so for two further reasons:

PL-LCD optics will be simpler and cheaper than equivalent optics for a conventional display as they need only be monochromatic or quasi-monochromatic. In conventional displays these optics would need to be adequate for wideband (i.e. white) light. Generally speaking this would perhaps double the cost, as singlet lenses adequate for monochromatic light would have to be doublet lenses to mitigate the effects of wavelength dispersion.

In a conventional system the resolution of the image formed is the resolution that the eye sees. This is not so for the PL-LCD architecture because the secondary or output screen effectively re-samples the image in a way that is analogous to digital sampling in the time domain. The re-sampling occurs where a black matrix is included on the output screen. If the resolution of the optics is low then, in a non-technical sense, the image of each pixel is ‘fuzzy’ rather than sharp. Around the fuzzy edges the light will fall onto the black matrix rather than the neighbouring pixel and therefore will have no effect on the resolution of the overall image—thus the final resolution is that defined by the phosphors on the output screen, not the optics. Low resolution will result in a certain amount of loss (where activation light falls onto black matrix rather than phosphor), whilst in the absence of a black matrix, or if it is small in relation to the resolution of the optics, then the observed effect is to introduce a certain amount of inter-pixel crosstalk. This can lead to a reduction in observed resolution, but in practice the first effect is loss of colour saturation.

As a general point it should be noted that it is the image that is seamless, not necessarily the output screen on which the image is formed. Preferably the screen itself is continuous over the area of the fully tiled image but in some embodiments the screen itself may also be formed of sub-elements tiled together in a way that is analogous to that of the modulators (but necessarily without similar ‘dead-space’). For the purposes of this application the terms ‘seamless image’ and ‘seamless display’ should be considered synonymous.

For further understanding of the invention embodiments of it will now be described, purely by way of example, with reference to the accompanying diagrams in which:

FIG. 1 shows a flat-panel modulator in accordance with the invention, exhibiting pixel blocks;

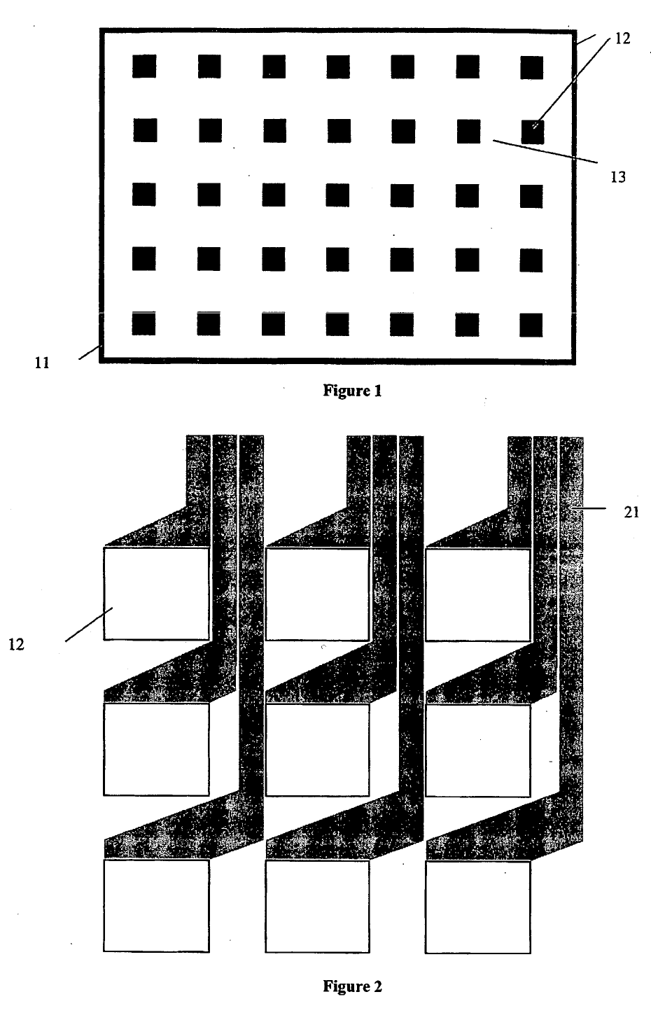

FIG. 2 shows how blocks of pixels can be individually addressed by columns;

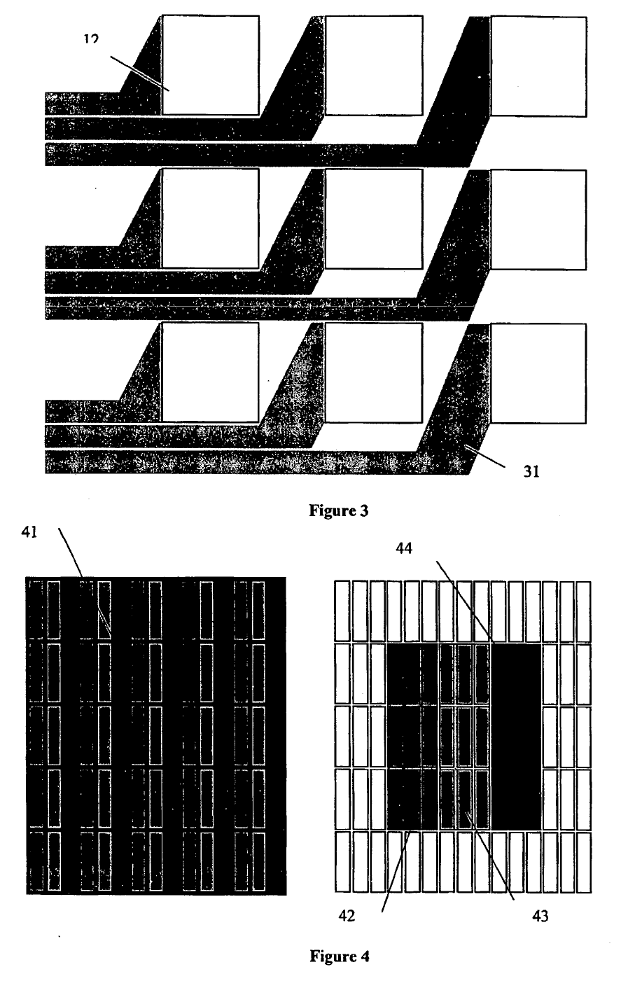

FIG. 3 shows how blocks of pixels can be individually addressed by rows;

FIG. 4 shows a scheme whereby pixels of different sizes, or indeed blocks of pixels, can be ‘created’ by suitable addressing of existing pixels;

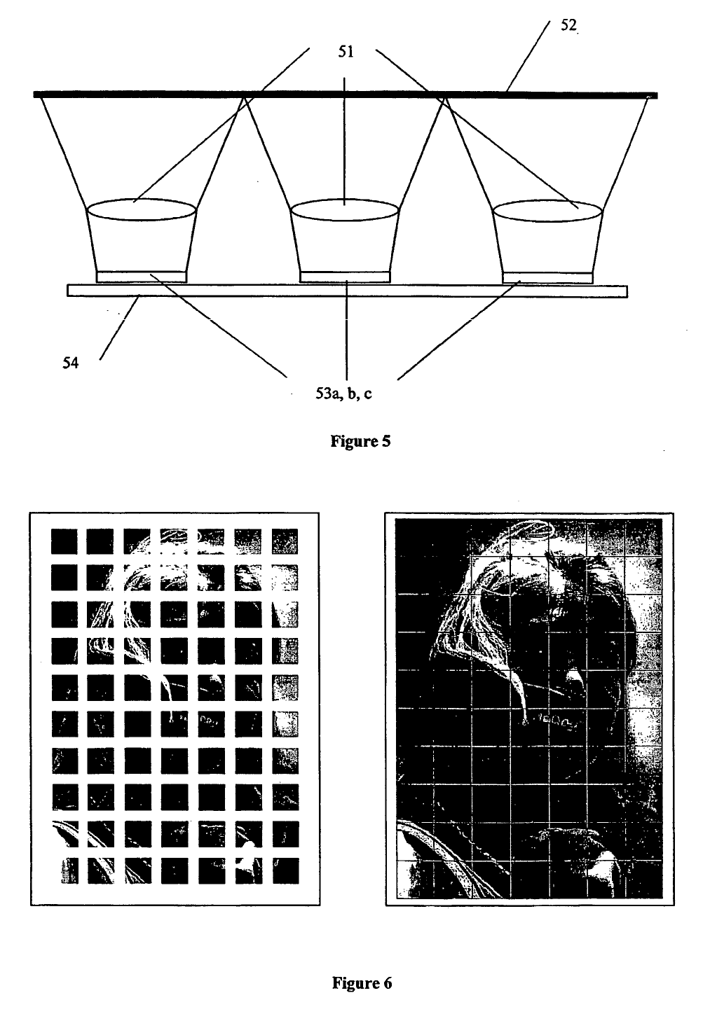

FIG. 5 shows diagrammatically an optical arrangement for a display embodying the invention;

FIG. 6 demonstrates the principle of composite imaging;

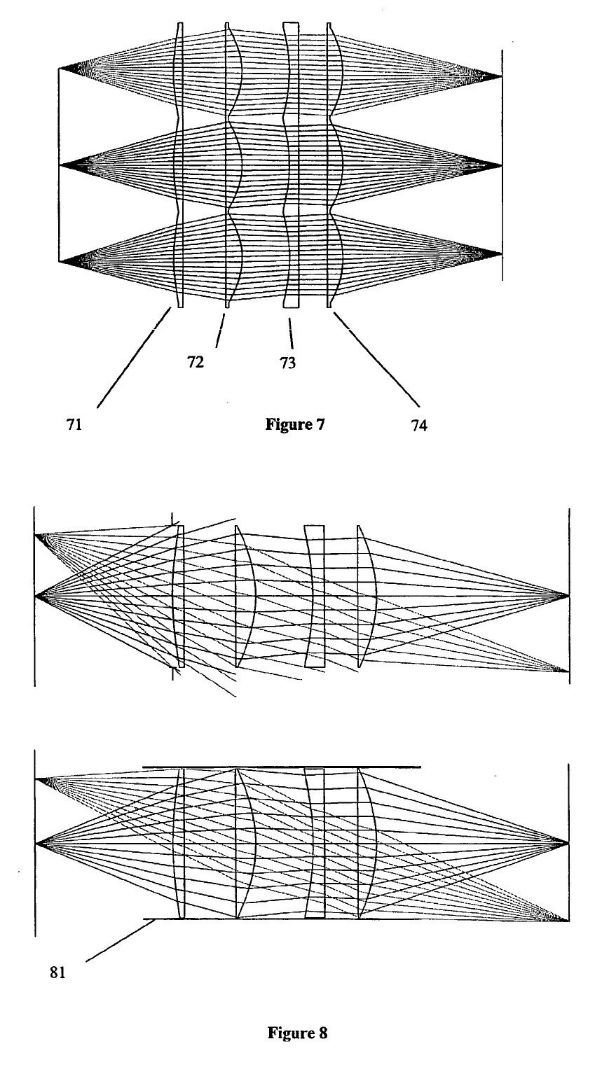

FIG. 7 shows a ray trace diagram of three sets of independent optics;

FIG. 8 shows a mini-lens with an additional vignetting means;

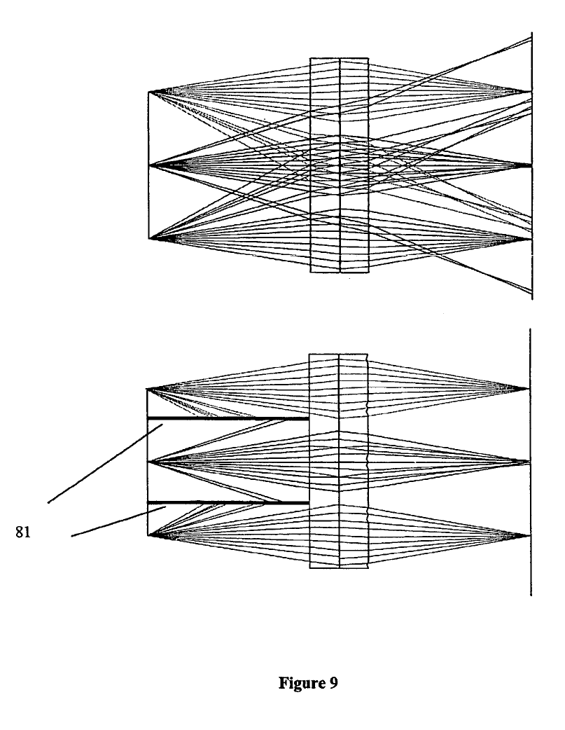

FIG. 9 shows how a vignetting means ensures sets of optics that are independent;

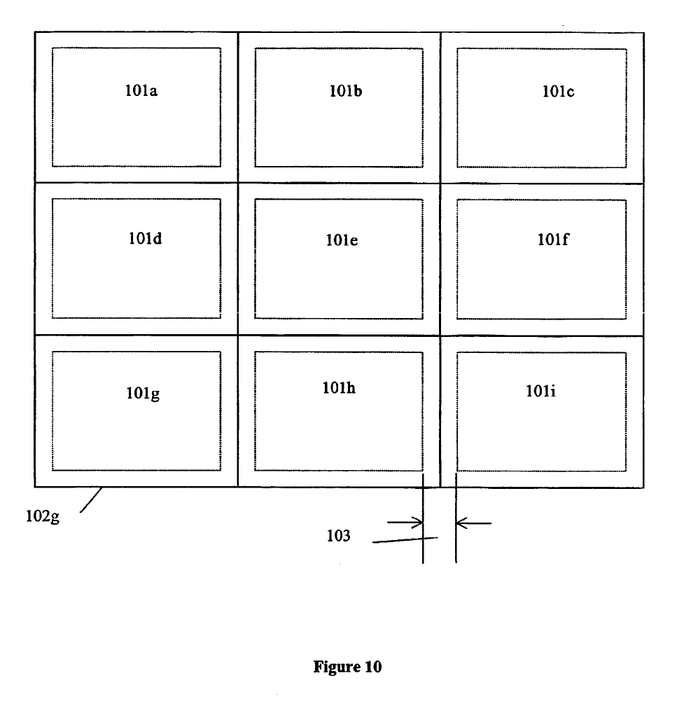

FIG. 10 shows a display according to a second display embodiment of the invention, namely a tiled display;

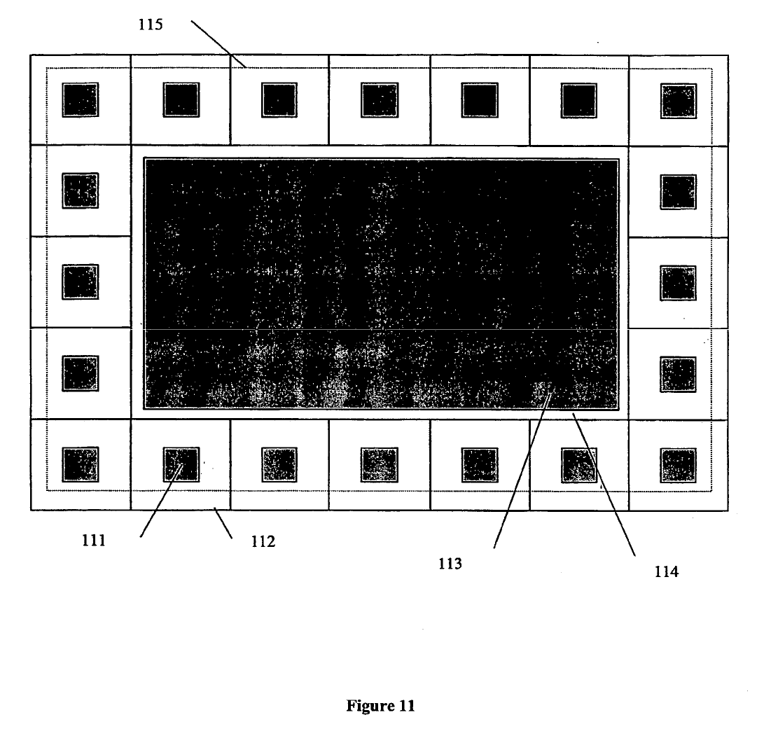

FIG. 11 shows a third embodiment, namely a non-uniform version of the first embodiment of the invention, that is, a peripheral-magnification scheme;

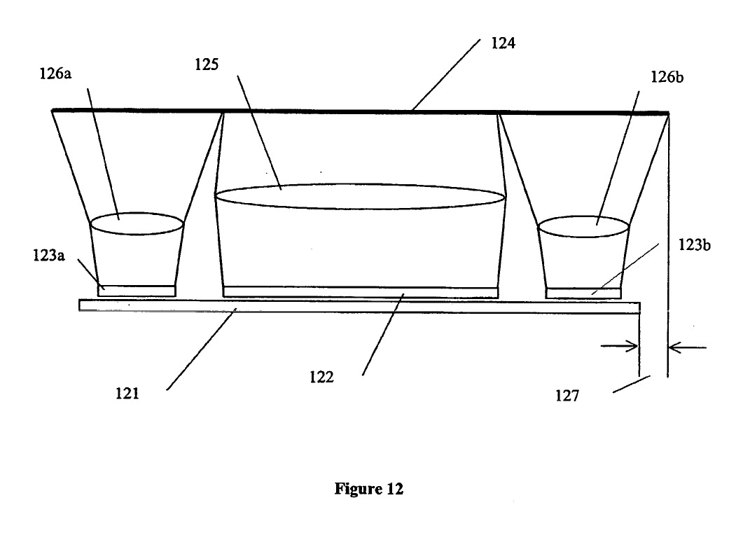

FIG. 12 shows a diagrammatic cross section through a display such as that shown in FIG. 11;

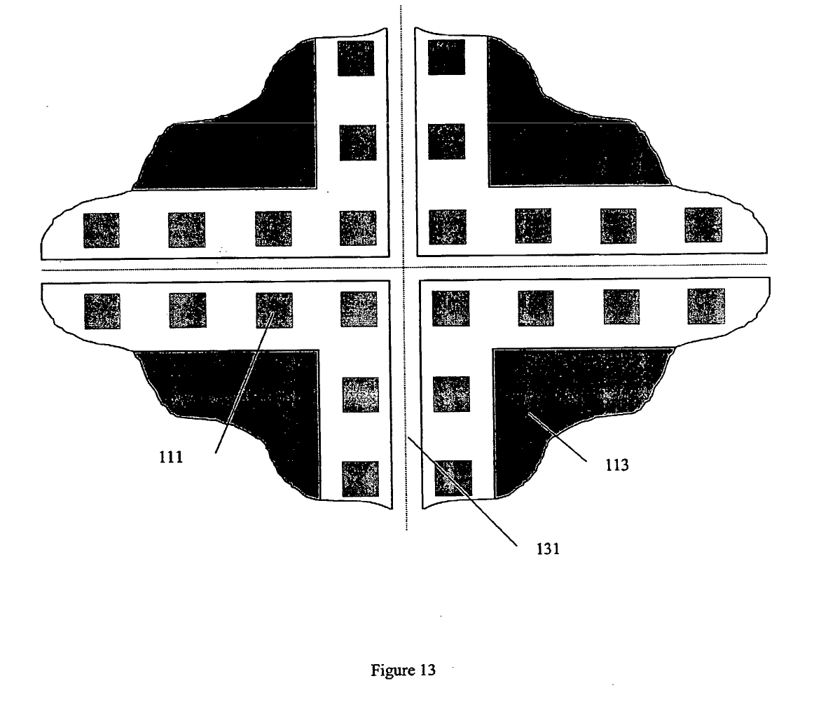

FIG. 13 shows how four modulators embodying the peripheral-magnification scheme can be tiled together;

FIG. 14 shows with extra detail how a composite image is formed on a modulator embodying a uniform version of the modulator;

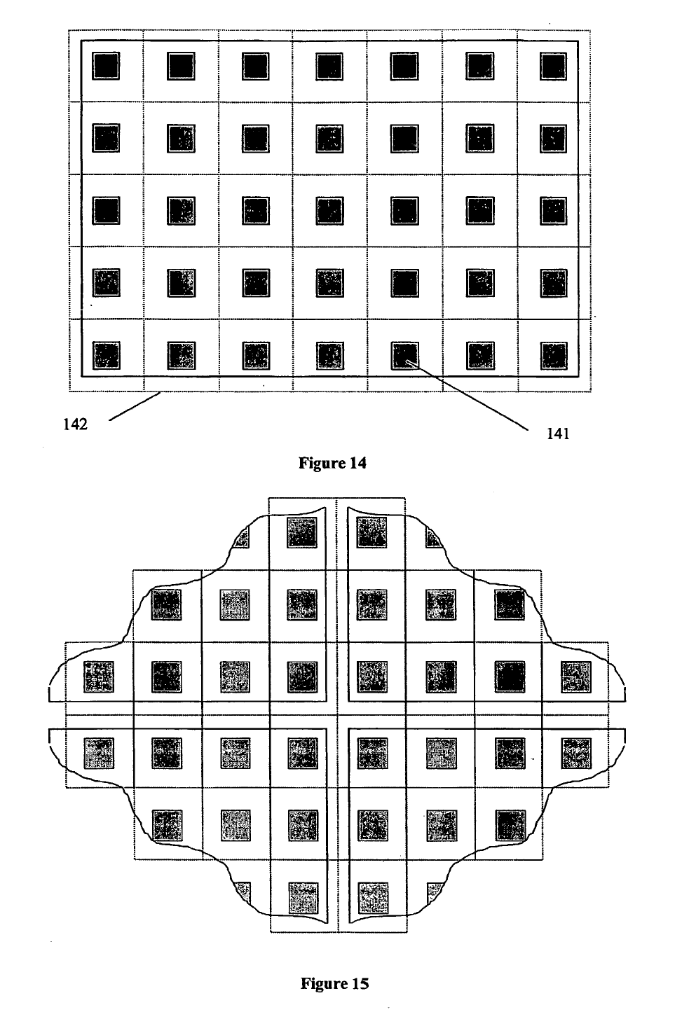

FIG. 15 shows how four modulators similar to the one in FIG. 14 can be tiled together;

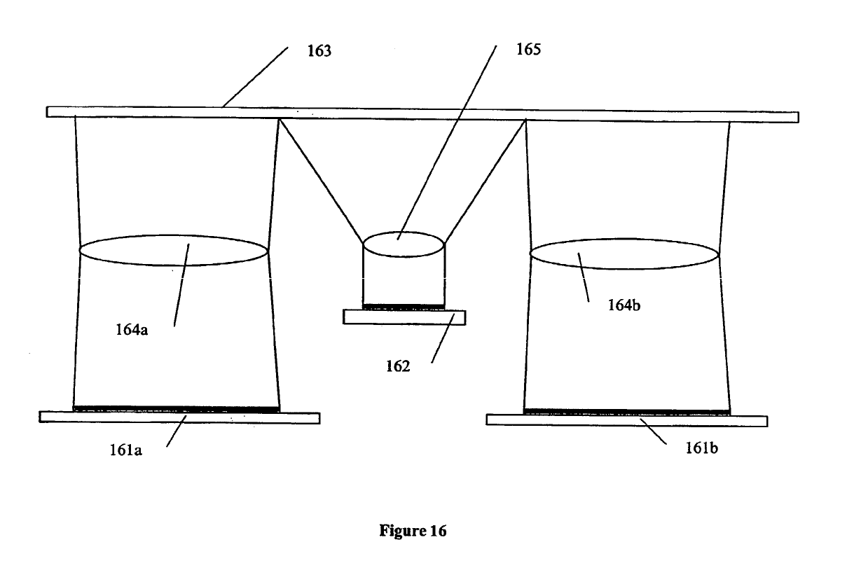

FIG. 16 shows a display according to an alternative embodiment of the peripheral-magnification version;

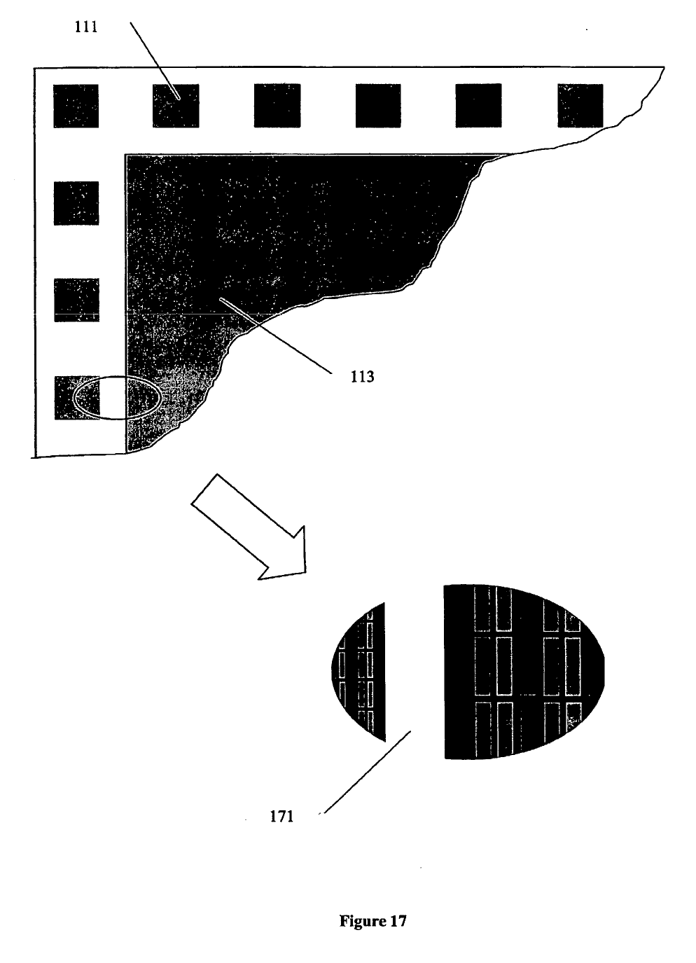

FIG. 17 demonstrates the variation in pixel size that is implied by a non-uniform scheme;

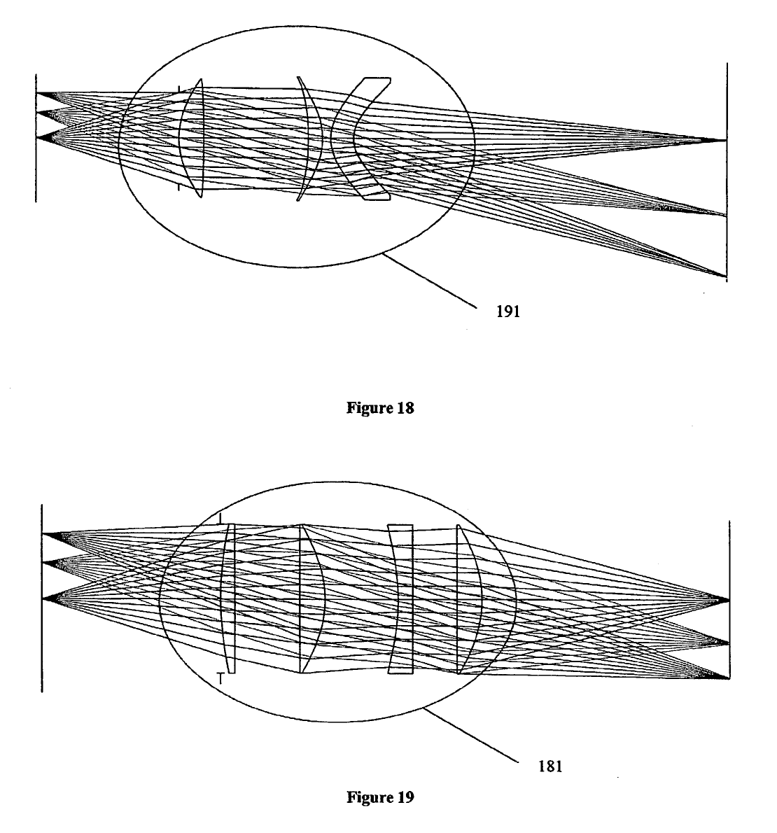

FIG. 18 shows a single compound mini-lens;

FIG. 19 shows another compound mini-lens, in fact a three-element lens, for the purposes of peripheral magnification;

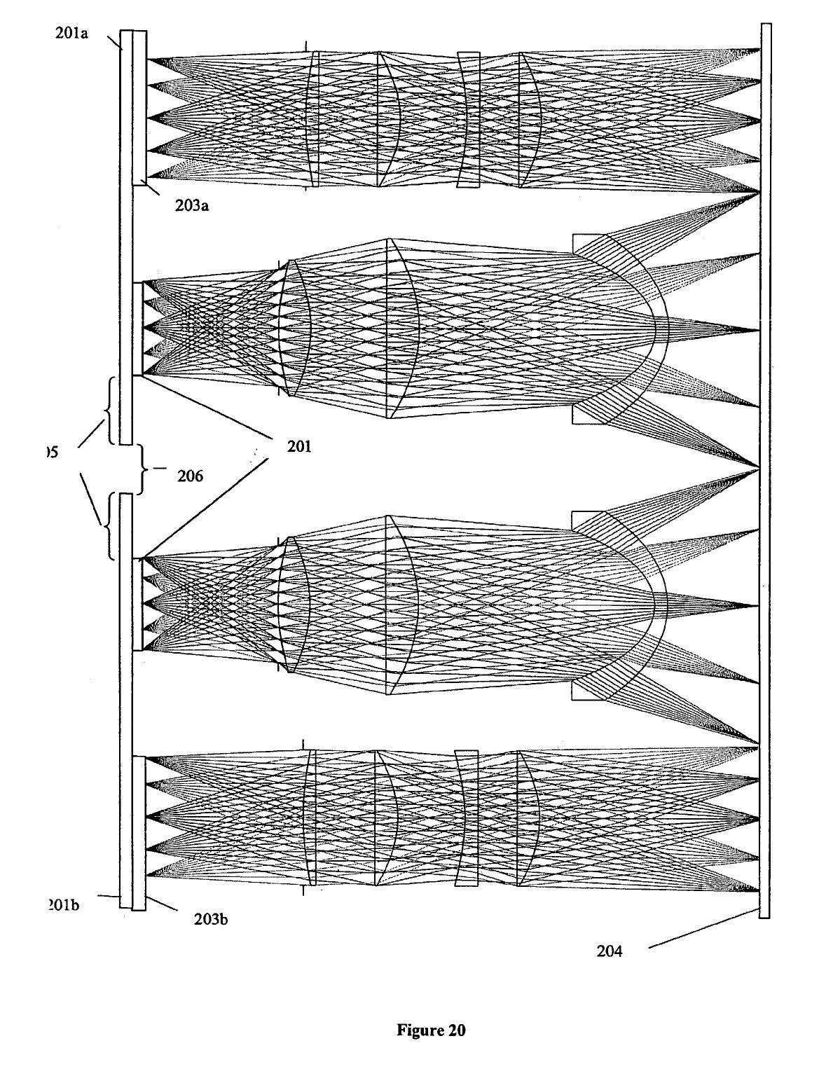

FIG. 20 shows how the combination of mini-lenses and pixel blocks can embody the second application of the invention; and

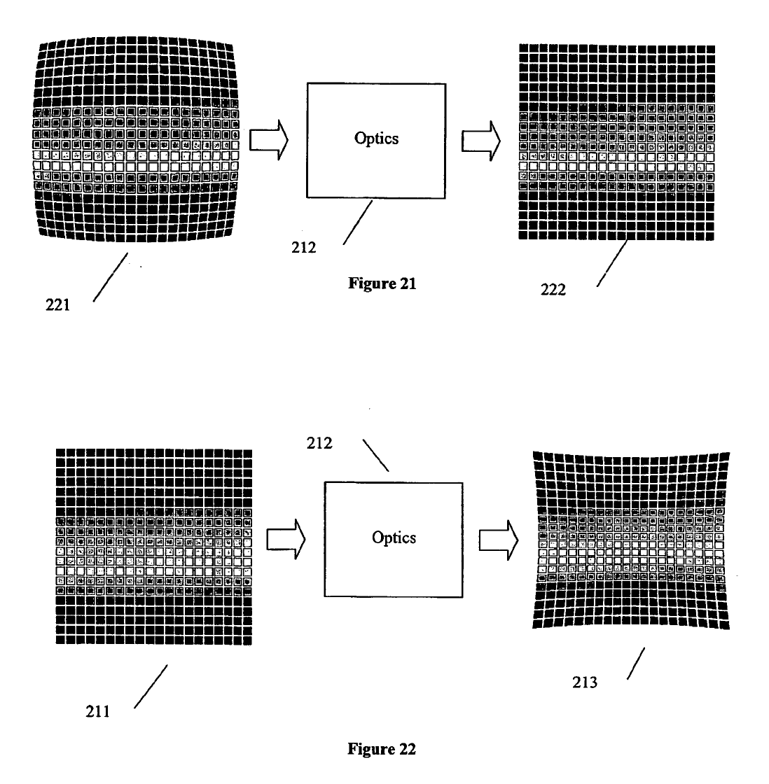

FIG. 21 and FIG. 22 show how pin-cushion or barrel distortion can be corrected.

In these figures the backlight or other means for producing the activation light is generally omitted for clarity, but such a backlight, preferably including one or more UV- or near-UV-emitting tubes, will in general be provided.

FIG. 1 is a simple depiction of a flat-panel modulator showing the modulator 11 and a plurality of blocks or patches of pixels 12. The space 13 between the pixel blocks does not contain modulating elements. In this case the distribution of patches is uniform.

FIG. 2 shows the concept by which blocks of pixels can be individually addressed by columns. In this case a 3×3 array of blocks is shown; the grey areas 21 depict column addressing lines for the pixel blocks 12. These addressing lines are placed in the space between pixel blocks that would be taken up with pixels in a prior-art modulator. This aspect of the invention will in the first instance allow, for the case of a passively addressed modulator, the level of multiplexing on any one column of pixels to be reduced. Additionally methods other than conventional row-at-a-time addressing can also be exploited; for example, a row in each block can be addressed simultaneously. In this way the rate at which an entire frame of data can be scanned onto the modulator can also be increased. A further approach would be to use a much more random or arbitrary scheme for row addressing.

In this figure the pixel blocks denote, in one sense, the parts of the modulator that have to be transparent to the activation light—of course, in the known manner, pixels are delineated with a transparent electrode, most commonly Indium Tin Oxide. However in the case of modulators according to the invention, there are areas of the modulator that need not be transparent; in general these will be space between pixel blocks. In this figure, therefore, the addressing tracks 21 need not be made from a transparent conductor and can therefore be deposited from a suitable metal, thus dramatically lowering track resistance and increasing potential frame-scanning rates even further. In the extreme, of course, only actual pixels are transparent and moreover the backlight is structured so that only pixels are illuminated, which increases efficiency. -

FIG. 3 shows how row addressing can also be varied in a way entirely analogous to column addressing. In this case individual blocks of pixels 12 on any one row can be addressed independently of each other by row addressing lines 31. In the extreme, this is implemented in addition to independent column addressing, in which case all blocks on the modulator can be addressed independently of each other.

In general any degree of row and/or column independence of pixel blocks allows methods other than standard row-at-a-time addressing to be used. The extreme method is that all blocks are independent, in which case all blocks could be addressed simultaneously. On the other hand blocks could be addressed in a completely random or arbitrary manner; for instance, if images were being decoded from an MPEG stream, individual blocks of pixels are changed from frame to frame according to displacement vectors. This might lead to pixel blocks being re-addressed in a manner that did not correspond to simple row or column order.

FIG. 4 shows the scheme whereby pixels of different sizes, or indeed blocks of pixels, can be ‘created’ by suitable addressing of a uniformly pixellated modulator. A series of conventional pixels 41 is shown together with three larger pixels 42, 43 and 44 which would be created by addressing nine smaller pixels together. This embodiment has the disadvantage that space between pixel blocks is not free to enable blocks to be individually addressed, but such a modulator is a much more straightforward adaptation of prior-art modulators.

FIG. 5 shows diagrammatically a display embodying the invention, with an optical arrangement 51 arranged to produce a composite image of the pixels-on the output screen 52. Three pixel blocks or patches 53a, 53b and 53c are indicated; for clarity only they are shown as separate from the LCD panel 54, whereas in fact they are within it. The backlight is also omitted for clarity. The panel may be a conventional large (30 cm) LCD panel, for instance, or it may be specially configured so that the spaces between the patches are devoid of pixels or are at least inactive. The substrate (e.g. the lower glass plate) is transparent, at least below the patches 53. The optics depicted in this figure act to project the plane of the modulator onto the plane of the output screen, but it will be apparent that this projection is different from the prior art in that the entire plane is not projected as one; rather, separate components of it (i.e. the pixel blocks that are relatively small in comparison with the throw from modulator to screen) are actually projected separately so that the images abut.

The modulator panel 54 may be a conventional actively or passively addressed LCD panel, including two glass substrates with a liquid crystal and orthogonal electrodes between them. In this case each patch can be addressed only in the usual way, by multiplexing from the edges of the panel, and the gaps between the patches are simply pixel areas that are not used, or blanked out. Wiring can be laid along the gaps to reach other panels or other electrical components.

Alternatively the panel 54 can be specially constructed, with each patch separately addressable, in which case the wires running in the gaps could be used to address the patches themselves, as in FIG. 2. Such a construction could be achieved by having a single glass or other transparent substrate on which separate LC cells are formed corresponding to the patches.

FIG. 6 demonstrates the concept of composite imaging. The left-hand image shows the individual blocks, although again for clarity these have not been inverted which would be the case if a mini-lens optical arrangement was being used. As can be seen, there is a spacing between the blocks, through which address lines can be passed. The right image is the fully ‘assembled’ composite image in which the image blocks are without gaps. In this case, for the purposes of further description of the concept a grid has been overlaid onto this image showing where the joins between the blocks would lie. Comparison of the two images will show that each block has been magnified in the composite image.

FIG. 7 is a ray trace through three sets of independent optics such as can be used for the invention. In this case the optics are of the mini-lens variety, in fact consisting of four arrays of mini singlet lenses 71, 72, 73 & 74. As can be seen, bearing in-mind that the design represents output from a ray-tracing package and therefore the ray paths shown are obeying Snell's Law, the ray paths are in fact independent from one set of optics to another.

FIG. 8 shows a mini-lens with and without vignetting means 81. Where vignetting is employed it ensures optical independence from a neighbouring mini-lens. This figure also shows how a lens has a particular acceptance angle for rays passing through it. Rays outside these angles are rejected in the sense that they miss a lens surface and are absorbed or blocked by the vignetting means. If the backlight is suitably collimated, it is possible to omit the vignetting means. Depending on the efficiency of such a collimated backlight, this may lead to better efficiency overall.

FIG. 9 shows how vignetting is employed to ensure that the sets of optics are independent. The top diagram shows how some rays from one block can pass through the optics of a neighbouring block. In the bottom diagram vignetting means 81 prevent these rays from entering the neighbouring optics. In the case of this figure, the optics are in fact a set of micro-lens arrays; this means that there is no physical distinction between sets of independent optics unless vignetting means are employed. The vignetting solution described here and elsewhere has the advantage that an un-collimated backlight can be used, although the light is that is blocked by the vignetting means represents a system loss. Alternative embodiments collimate the backlight in such a way that light does not leave a pixel block on paths that would take the rays to a neighbouring set of optics.

FIG. 10 shows a display according to a development of the invention. Here nine individual modulator panels 101a-101i have been tiled together in a single assembly to form one large display. The optical arrangement is adapted in such a way that the images 102a-102i of each separate modulator are larger than the actual modulator by exactly the right amount to form a composite image over all nine individual modulators (to avoid cluttering this diagram only one image 102g is actually denoted). The magnification of each image generates or allows a space 103 between each modulator; this space is utilised both for the mechanical aspects of such an assembly and also to afford room for electrical connections to each modulator.

FIG. 11 shows diagrammatically and in plan view a display according to a non-uniform embodiment of the modulator of the invention, namely a peripheral magnification scheme. Each peripheral patch 111 has a magnified image 112. The central region 113 also has its image 114, shown here slightly magnified for clarity only. As can be seen all the various images adjoin, producing an overall magnified image of the display on the LCD panel and an overall image that is also larger than that of the panel 115 itself.

FIG. 12 shows a diagrammatic cross section through a display such as that shown in FIG. 11. An LCD panel 121 has the aforementioned central region 122 and peripheral patches 123a and 123b, again all part of the same modulator panel. Three sets of optics are shown: the central optics 125, which in this case/image the central region 122 with unity magnification; and two sets of peripheral optics 126a and 126b. The optics are interposed between the LCD panel 121 and the output screen with phosphors 124. The peripheral optics are the same for all the peripheral patches (although this is not a mandatory requirement) and in this case magnify their respective peripheral patches in such a way that the images of the central and peripheral regions exactly adjoin. In this way the full extent of the image on the output screen 124 is larger than the underlying panel 121. The purpose of this particular peripheral scheme is to enable tiling of several such panels. In this case the magnification of the peripheral patches creates extra space 127 which is sufficient for a further LCD panel (not shown) to placed in an array without creating the dead space effect in the observed image on the output screen.

FIG. 13 shows four modulators similar to that shown in FIG. 11 tiled together to form a single larger display assembly. Each display has a central region 113 and a plurality of peripheral patches 111. Each peripheral patch is magnified so that the composite image of the modulator is delineated by the dotted lines as shown. In this way four such modulators can be tiled together whilst still allowing room 131 between individual modulators for the mechanical and electrical aspects of the tiled modulator assembly.

FIG. 14 shows with extra detail how a composite image is formed according to a variant embodiment of the modulator of the invention in which the blocks are uniform. A number of blocks of pixels 141 are shown, each of the same size and orientation and distributed evenly over the entire area of the modulator, except that the blocks are closer to the edge of the modulator than to adjacent block areas. An optical arrangement (not shown) magnifies each patch to produce the composite image 142.

FIG. 15 shows how four (or more) modulators each similar to that shown in FIG. 14 can be tiled together. This embodiment is an alternative to that shown in FIG. 13 and has the advantage that brightness variations are avoided.

FIG. 16 shows how two modulator panels 161a and 161b can produce a seamless image by use of a separate peripheral modulator 162 according to this embodiment of the invention. The image displayed on the two main modulators is relayed or transferred to the output screen 163 by relay optics 164a and 164b. The dead space that would otherwise occur is effectively ‘filled in’ by the image of the peripheral modulator, between the main modulators and in this instance somewhat closer to the output screen 163, magnified by magnification optics 165. In this figure the optics 164a and 164b are referred to as relay optics because they are performing unity magnification, although this is not mandatory. In this kind of arrangement the pixels on the individual modulators need not be divided into patches.

FIG. 17 shows how the pixel size will vary where a non-uniform scheme is employed. In this case a peripheral magnification scheme is described. Peripheral patches 111 and a central region 113 are shown together with an expanded view of a portion of one peripheral patch and a portion of the central patch; this view clearly shows the variation in pixel size (albeit not necessarily to scale).

FIG. 18 and FIG. 19 show ray traces through two different mini-lenses. Lens 181 is a four-element compound lens, each element being a singlet. This particular design achieves a slight degree of magnification and the total track from object to image is approximately 100 mm. The ray trace clearly shows inversion of the image with respect to the object. Lens 191 is a three-element lens for the purposes of peripheral magnification to a degree much greater than that of the central optics 181.

FIG. 20 also shows ray paths, this time for a tiled application, in section. Two modulators or LCD panels 201a and 201b are shown being tiled together (note that the entirety of the LCD panels is not shown). Also shown are two peripheral patches 202 and the first two central patches 203a and 203b. These are imaged by the optics onto the output screen 204. In that the degree of magnification provided for by the optics at the periphery is different (i.e. greater) than that of the other optics; this figure thus represents a non-uniform embodiment of the invention. It is similar to previously described peripheral-magnification schemes except that the single central patch is sub-divided into further patches, of which one on each panel is shown; the associated optics provide slight magnification, in this case. This is done because it facilitates design and manufacture of the mini-lenses. Two types of gap are also indicated: first there is a gap 205 between the edge of the peripheral patch 202 and the edge of the modulator, secondly there is a gap 206 between the two modulators. In principle, no matter how the modulators are mounted in a matrix, these two types of gap are present, the width of the panel edge gap 205 is determined by the mechanical construction of the modulator; the width of the other gap 206 is determined by the necessary connections that need to be made to the modulator at this point and the mechanical arrangement that supports the modulators in the regular array. Typically a total gap width (all three gaps together) of 20 mm is adequate.

FIG. 21 shows the effect of pin-cushion optical distortion; a recti-linear array of pixels 211 is imaged and distorted by the optics 212, producing the pin-cushion-like effect 213.

FIG. 22 shows how this distortion can be corrected by modification of the pixel layout. Because pin-cushion and barrel distortion are the opposite of each other, the correct barrel-shaped pixel arrangement 221, when imaged by the same optics 212, produces the correct pixel pattern on the output screen 222.

In the above figures, grey areas have generally depicted where pixels are or are meant to be, the white areas indicating where there are no pixels, that is, where no light is to be modulated. However, as described above, the distinction between the two areas can be realised in different ways; that is, the white areas could physically represent areas where there are no pixels, or no areas in which the liquid crystal can be addressed. On the other hand they could be areas containing pixels which are not addressed. In either case the white areas would be masked off to prevent light passing through them.

In general the modulators have been referred to as liquid-crystal panels; however, it should be understood that they could be any sort of electro-optic modulator. In addition, the output screen has generally been described as carrying phosphors, but these could be any photo-luminous material. The preferred arrangement for these is in a colour triad arrangement with a black matrix as is known for PL-LCD displays (and is also shown in FIG. 4 and FIG. 17).

In order to improve overall system efficiency it may be appropriate to coat the optics with an anti-reflection coating; again this could be done for conventional white light systems but PL-LCD architectures are advantageous because mono-chromatic anti-reflection coatings are simpler than wideband ones. A further advantage over conventional rear-projection displays with diffusing screens exists in that the output screen carrying the phosphors can be coated with a dielectric filter as described in WO 98/52359 which will act to increase system efficiency by reflecting forwards any rearwardly emitted visible light.

It has also been assumed that the pixel layout on a modulator is recti-linear in the normal fashion and that the layout of pixel blocks is also recti-linear. In this case the meaning of the terms ‘row’ and ‘column’ is obvious. However it should be understood that other arrangements, particularly other block layout arrangements, could be used. For example a hexagonal array has some advantages.

Activation light has been referred to throughout; this is preferably narrow-band UV light with a central wavelength of 388 nm and a bandwidth of approximately 15 nm. However it could be any other appropriate narrow-band source, such as a narrow-band visible blue source. Furthermore the methods described here could be applied to a conventional (i.e. non PL-LCD) architecture, in which case the activation light would be replaced by ‘normal’ white light and the output screen would carry diffusing elements instead of phosphors. Where colour is required this could be done either by including colour filters in the modulator panels as normal, or by including them on the output screen.

| Figure | Item | Description |
|---|---|---|
| 1 | 11 | Modulator |
| | 12 | Pixel blocks |
| | 13 | Space between pixel blocks |
| 2 | 21 | Column addressing lines |
| | 12 | Pixel blocks |
| 3 | 31 | Row addressing lines |
| | 12 | Pixel blocks |
| 4 | 41 | Conventional pixels |
| | 42 | Larger pixel |
| | 43 | Larger pixel |
| | 44 | Larger pixel |
| 5 | 51 | Optical arrangement |
| | 52 | Output screen |
| | 53a, b, c | Pixel blocks |
| | 54 | LCD panel |
| 6 | | |
| 7 | 71 | Mini-lens array |
| | 72 | Mini-lens array |
| | 73 | Mini-lens array |
| | 74 | Mini-lens array |
| 8 | 81 | Vignetting means |
| 9 | 81 | Vignetting means |
| 10 | 101a-i | Individual modulator panels |
| | 102a-i | Images |
| | 103 | Space between panels for assembly |
| 11 | 111 | Peripheral patch |
| | 112 | Magnified image of peripheral patch |
| | 113 | Central region |
| | 114 | Image of central region |
| | 115 | LCD panel |
| 12 | 121 | LCD panel |
| | 122 | Central region |
| | 123a, b | Peripheral patch |
| | 124 | Phosphor output screen |
| | 125 | Central optics |
| | 126a, b | Peripheral optics |
| | 127 | ‘Extra space’ |
| 13 | 113 | Central region |
| | 111 | Peripheral patch |
| | 131 | Room between individual modulators |
| 14 | 141 | Blocks of pixels |
| | 142 | Composite image |
| 15 | | |
| 16 | 161a, b | Modulator panels |
| | 162 | Peripheral modulator |
| | 163 | Output screen |
| | 164a, b | Relay optics |
| | 165 | Magnification optics |
| 17 | 113 | Central region |
| | 111 | Peripheral patch |
| | 171 | Expanded view |
| 18 | 181 | Compound lens |
| 19 | 191 | Compound lens |
| 20 | 201a, b | LCD panels |
| | 202 | Peripheral patches |
| | 203a, b | Central patches |
| | 204 | Output screen |
| | 205 | Gap between peripheral patch and edge |
| | | of modulator |
| | 206 | Gap between two modulators |
| 21 | 211 | Recti-linear array of pixels |
| | 212 | Optics |
| | 213 | Pin cushion like effect |
| 22 | 221 | Barrel shaped arrangement of pixels |
| 23 | 212 | Optics |
| 24 | 222 | Correct pixel shape |

1. A flat-panel modulator including a plurality of separately modulatable elements or pixels, in which the modulating elements are arranged into patches or blocks (12, 53) of individual modulating elements such that space (13) between each patch exists which has no modulating elements.

2. A modulator according to claim 1, in which the space between the patches on the modulator carries conductors (21) to allow individual blocks within a row or column of blocks to be addressed independently of other blocks in the same row or column.

3. A modulator according to claim 2 and including drive means adapted to address the independently addressed blocks of pixels within a column of blocks simultaneously or in a random/arbitrary order rather than consecutively.

4. A modulator according to any of claims 1 to 3, in which the space between the patches on the modulator carries conductors to allow individual blocks within a row of blocks to be addressed independently of other blocks in the same row.

5. A modulator according to claim 4, and including drive means adapted to address the independently addressed blocks of pixels within a row of blocks consecutively or in a random/arbitrary order rather than simultaneously.

6. A modulator according to any preceding claim and being constructed on a single transparent substrate.

7. A modulator according to any preceding claim, in which pixels are made from a transparent conducting material and addressing lines are made from or include a metallic or non-transparent conducting material of lower resistivity.

8. A modulator according to claim 7, in which the improved RC time constant of the addressing lines is utilised to address the entire array of pixels more quickly than if a higher-resistivity material had been used.

9. A modulator according to any of claims 6 to 8, in which the viscosity of the liquid crystal is lower than the lowest viscosity of a liquid crystal that could be used if the entire panel were addressed as a whole, without introducing frame response artifacts.

10. A modulator according to any preceding claim, in which the patch (141) size is uniform across the modulator.

11. A modulator according to any of claims 1 to 9, in which the patches (111) around the periphery are smaller than those (113) in the centre of the modulator.

12. A modulator according to claim 11, in which there is only one large central patch (113) and a plurality of smaller patches (111) around the periphery of the central patch.

13. A flat-panel modulator including a plurality of separately modulatable elements or pixels and a driver for addressing them, in which the driver addresses a plurality of pixels in parallel in such a way that the effect is of a single larger pixel, and a plurality of such larger pixels are addressed on the entire modulator.

14. A flat-panel modulator including a plurality of separately modulatable elements or pixels and a driver for addressing them, in which the driver addresses pixels in patches or blocks of individual pixels in such a way that the pixels between each patch are not modulated.

15. A display comprising:
a modulator (54) according to any of claims 1 to 14;
a means, such as a backlight, for producing narrow-band or substantially monochromatic activation light;
an output screen (52) containing photo-luminous output elements or materials which emit visible light in response to the activation light; and
an optical arrangement (51) for projecting the plane of the modulator onto the output screen in such a way that the image of each patch is projected onto the output screen in order to create a composite image on the output screen.

16. A display according to claim 15, in which each patch is projected with unity or greater than unity magnification so that the composite image is larger than the modulator.

17. A display according to claim 15 or 16 and including a plurality of such modulators arranged in a regular array or matrix, in which the projected composite image (142) of each individual modulator is larger than that modulator by a sufficient amount to allow a seamless composite image of all the modulators to be formed on the output screen.

18. A display according to claim 15 or 16 and including a plurality of such modulators (161) arranged in a regular array or matrix, and a plurality of additional peripheral modulators (162) each with an associated but separate magnifying optical arrangement (165);
in which images of the modulators and peripheral modulators are projected onto the output screen in such a way that the images of the all the modulators together form a seamless image on the output screen.

19. A display according to claim 18, in which the modulators and peripheral modulators occupy substantially the same plane.

20. A display according to claim 18, in which the modulators and peripheral modulators occupy different planes.

21. A display according to any of claims 18 to 20, in which the peripheral modulators are lit separately from the other modulators.

22. A display according to any of claims 15 to 21, in which the optical arrangements include one of or a combination of the following:
Mini-lenses, possibly consisting of one or more singlet lenses or arrays of singlet lenses;
Micro-lens arrays;
Gabor Super-lenses; and
GRIN lens arrays.

23. A display according to any of claims 15 to 22, in which the optical arrangement is such as would create pin-cushion or barrel distortion, but this is corrected for by adaptation of the shape and layout of the pixel blocks.

24. A display according to any of claims 15 to 23, in which the means for producing activation light is collimated.

25. A display according to any of claims 15 to 25, in which the means for producing activation light is un-collimated but vignetting between and/or within optical arrangements is employed to prevent image degradation.

26. A display according to any of claims 15 to 25, in which the activation light is narrow-band UV light, preferably with a central wavelength of 388 nm and a bandwidth of approximately 15 nm.

27. A display according to any of claims 15 to 25, in which the activation light is narrow-band visible blue light.

28. A display according to any of claims 15 to 27, in which the photo-luminous output screen includes photo-luminous output elements arranged in colour triads.

29. A display according to any of claims 15 to 25, except that the output screen contains only diffusing elements instead of photo-luminous output elements and the backlight produces visible light.

30. A display according to claim 29, in which the backlight produces white light and colour filters are included on the output screen or the modulators.
